(19) United States
(12) Patent Application Publication
(10) Pub. No.: US 2012/0318450 A1
(43) Pub. Date: Dec. 20, 2012

(54) Method for Producing a Thin Multi-Sheet Slab of Natural Stone

(75) Inventors: Juan Antonio Santo Sanchez, Alicante (ES); Vicente Gonzalez Penella, Alicante (ES); Cella Guillem Lopez, Alicante (ES); Angel Lopez Buendia, Alicante (ES)

(73) Assignee: Benicantil Marmoles, S.A., Alicante (ES)

(21) Appl. No.: 13/581,290

(22) PCT Filed: Feb. 9, 2011
(86) PCT No.: PCT/ES11/70086

§ 371 Date: Aug. 24, 2012

(30) Foreign Application Priority Data
Aug. 9, 2010 (ES) P201001065

(51) Int. Cl. B32B 37/14; B32B 37/12; B28D 1/22

(52) U.S. Cl. 156/257

(57) ABSTRACT

Manufacturing procedure for a multi-lamina product starting from laminas consisting exclusively of natural stone, joined by means of an adhesive component. The combination of laminas of high and low quality natural stone makes it possible to obtain exclusively high quality products with large formats and reduced thicknesses, and it also allows for an increase in the production of high quality products obtained starting from a single lamina of high quality original natural stone (FIG. 2). The innovation of the manufacturing procedure lies in the machining of grooves, the adhesion of laminas, the curing of the resin, and the splitting. By means of the proposed process (FIG. 1) it is possible to obtain multi-laminated products (FIG. 3) of reduced thickness and large format with high mechanical performance and durability, and which are easy to lay on site.

### FIELD OF INVENTION

The purpose of this invention is to describe a manufacturing procedure for obtaining a construction material of the type multi-lamina slab of natural stone of reduced thickness.

### BACKGROUND OF THE INVENTION

In the construction sector, use is made of materials and products of a very different nature depending on the performance and functionalities that are needed, along with their economic cost, as a facing for partitions and walls. In particular, a material that is much used as a facing is natural stone, due primarily to its physical and aesthetic properties, as well as to the fact of being unique on account of its natural origin. So, given that there exists a large quantity of varieties of natural stone, this allows for a wide range of products to be offered in terms of finishings and aesthetic appearance.

In spite of the great advantages of natural stone, one of the drawbacks in its use as a facing for buildings is its cost compared to other types of products, since it is obtained from a limited natural source. Also, another disadvantage lies in the mechanical performance of the material, which makes it necessary to resort to certain thicknesses of pieces in order to reduce the risk of breakage. In addition to an excessive consumption of raw material, this also implies a considerable weight of the pieces, which adversely affects the handling and transport costs.

In order to solve these drawbacks, a large number of production processes, systems and products associated with this problem have been patented in recent decades. Nevertheless, the shortcomings have not been wholly overcome. Stated below are a series of solutions related to the problem raised here.

A marble slab coloured in order to overcome the limitation on original colour so as to make the final product translucent; while the present invention concerns a single stone material with different qualities.

Certain inventions develop products comprising two slabs of different material, specifically, one of natural stone and the other of a different material (such as ceramic, limestone, polyurethane, etc.), and the former can even include a strengthening stage; on the contrary, the present invention uses the same material with different qualities and there is no reinforcing covering as such, solely an adhesion which has a different manufacturing process since just two pieces are being joined.

On the other hand, there exist processes which describe a product made of stone formed from two slabs of the same material, but with different aesthetic qualities and identical dimensions. Nevertheless, the present invention presents a manufacturing procedure for a multi-lamina product based on products of the same material with different quality but with dimensions that can be different.

Also, the gluing of the laminas incorporates some groves for stiffening and strengthening the adhesion of the laminas in order to facilitate their laying.

Unlike other inventions, the present invention concerns a productive process where sets of pieces are obtained by combining products of good and bad quality, and also grooving operations are carried out consisting of a manufacturing process for various sets of adhered pieces which are cut by means of a process of splitting, where the vertical cut of them is made by mechanical means in order to later on divide the set of pieces.

### SUMMARY OF THE INVENTION

The invention consists of a manufacturing procedure for a multi-lamina slab for use in construction based on natural stone.

The multi-lamina slab comprises three layers, an upper one with one or several laminas of low quality stone, a central layer comprised of a lamina of high quality stone of thickness approximately double that of the final product, and a lower layer comprised of one or several laminas of low quality stone.

Although, as has been explained, there exist patents which describe different manufacturing procedures for similar products, the present invention in particular contributes the following advantages to the state of the art:
The adhesion of the laminas making up the slab is stiffened and strengthened.
The finished product is easier to lay.
It is easier to manufacture.
The cost per unit of final product is reduced, since there are few breakages of the pieces.

### GENERAL DESCRIPTION OF THE PROCEDURE

Once the blocks of stone have been received, it is possible by means of a cutting operation to obtain essentially flat pieces which will present different qualities, with a set of laminas classified by quality being obtained as a result, having the necessary format and thickness.

Once the classification has been carried out, some grooves are machined in the two faces of each lamina, so that they have a suitable shape, arrangement and geometry.

Once the operation of machining the grooves is completed, an adhesive is then applied to the surface of the corresponding face of each lamina using a bi- component resin (of the type epoxy, polyurethanes, unsaturated polyester, etc), the laminas are then glued together and the resulting multi-lamina slab is then cured by microwave technology.

In order to end the process, the initial multi-lamina slab is then cut into two parts using a splitting machine.

Prior to proceeding to cutting the multi-lamina slab, this slab consists of the following pieces, as can be seen in FIG. 2:

a) One or more laminas of low quality stone (3), in the upper part.

b) A layer of adhesive (6).

c) A central layer of high quality stone (2).

d) A layer of adhesive (6).

e) One or more laminas of low quality stone (3), in the lower part.

After the splitting, the multi-lamina slab will consist of the following pieces, as can be seen in FIG. 3:

a) A central layer of high quality stone (2).

b) A layer of adhesive (6).

c) One or more laminas of low quality stone (3), in the lower part.

As shown in FIG. 2, all the laminas will have grooves on both faces so that, as well as successfully facilitating the adhesion among laminas, the laying of the multi-lamina product on site is also facilitated.

Finally, via conventional processes of surface treatment and finishing (calibrating, polishing, bevelling of edges, etc.) the final product is obtained ready for marketing.

### SUMMARY DESCRIPTION OF THE PROCEDURE

1.1) Cutting of blocks, obtaining pieces with essentially flat surfaces.

1.2) Classification of the pieces obtained according to quality criteria.

1.3) Machining of the outer (4) and inner (5) grooves specified in the production process.

1.4) Application of bi-component epoxy type resin adhesive (6) to the corresponding face, for the formation of the multi-lamina slab as can be seen in FIG. 2.

1.5) Gluing of the three layers making up the multi-lamina slab, according to the following order:
One or more laminas of low quality stone (3), laid on the same plane, one alongside the other in the upper part of the slab.
A central lamina of high quality stone (2).
One or more laminas of low quality stone (3), laid on the same plane, one alongside the other in the lower part of the slab.

1.6) Thermal and/or chemical curing of the multi-lamina slab.

1.7) Splitting or cutting of the multi-lamina slab, obtaining two pieces with materials of different quality.

1.8) Surface treatments.

1.9) Finishing treatment giving rise to a marketable final product.

### BRIEF DESCRIPTION OF DRAWINGS

In order to complement the description of this invention and with the aim of facilitating an understanding of its characteristics, a series of figures are attached in which, in an illustrative and basis without being limiting, the following figures have been represented:

(1) Flow diagram of the production process.
(1.1) Cutting of blocks.
(1.2) Classification by qualities.
(1.3) Machining of outer and inner grooves.
(1.4) Application of adhesive.
(1.5) Gluing of the laminas.
(1.6) Curing of resins.
(1.7) Splitting.
(1.8) Surface treatments.
(1.9) Finishing treatment.

(2) Lamina of high quality large format natural stone.

(3) Lamina of low quality natural stone.

(4) Outer grooving.

(5) Inner grooving.

(6) Adhesive.

FIG. 1 is a flow diagram of the main steps of the production process.

FIG. 2 is a diagram showing the composition of the multi-lamina slab in the step prior to splitting, composed of three layers. The upper and lower layers are laminas of low quality stone and the central layer is a lamina of high quality stone.

FIG. 3 is a diagram of the final product once the cut has been made.

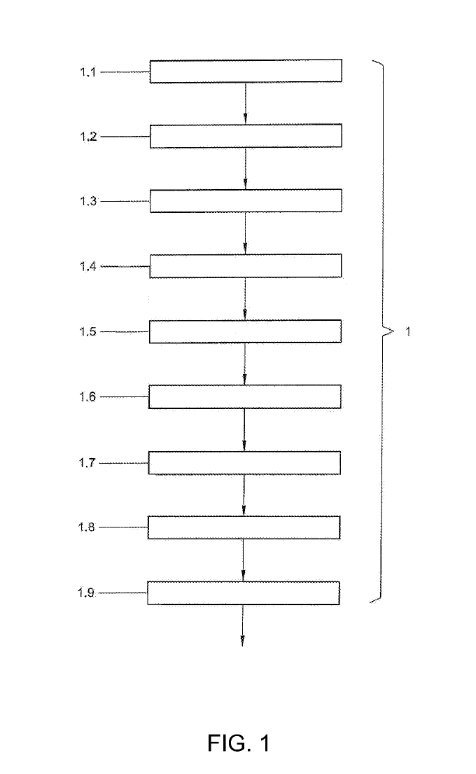

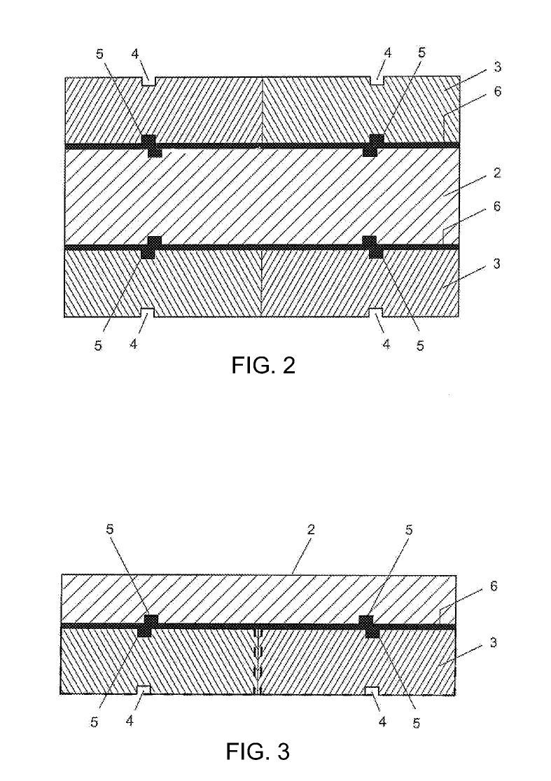

### DETAILED DESCRIPTION OF SEPCIFIC EMBODIMENT OF THE INVENTION

In relation to the aforementioned figures, described below is the preferred embodiment of the manufacturing procedure for a construction product of the type multi-lamina slab of natural stone with reduced thickness.

Before commencing the manufacturing procedure of the multi-lamina slab, the blocks of stone are first received in the manufacturing plant. These blocks are cut to obtain laminas of different qualities, which are then classified by quality, and with the necessary format and thickness. The detailed manufacturing procedure consists of the following steps.

1.1) Cutting of blocks, obtaining pieces with essentially flat surfaces.

1.2) Classification of the pieces obtained according to quality criteria.

1.3) Machining of the outer (4) and inner (5) grooves specified in the production process. The outer grooves (4), made on the outer surface of low quality laminas (3), have the function of facilitating the laying of the multi-lamina slabs.

The inner grooves (5), made on low quality laminas (3), have the function of facilitating the gluing between the laminas. These inner grooves (5) are made on both faces of the high quality natural stone laminas (2).

1.4) Application of bi-component epoxy type resin adhesive (6) to the corresponding face, for the formation of the multi-lamina slab.

1.5) Gluing of the three layers making up the multi-lamina slab, according to the following order:
One or more laminas of low quality stone (3), laid on the same plane, one alongside the other in the upper part of the slab.
A central lamina of high quality stone (2).
One or more laminas of low quality stone (3), laid on the same plane, one alongside the other in the lower part of the slab.

1.6) Thermal and/or chemical curing of the multi-lamina slab.

1.7) Splitting or cutting of the multi-lamina slab, obtaining two pieces with materials of different quality.

1.8) Surface treatments.

1.9) Finishing treatment giving rise to a marketable final product.

Having sufficiently described the nature of this invention, along with a practical application thereof, it only remains to add that the procedure for obtaining the laminas that has been described is susceptible to modifications, always provided they do not substantially affect the characteristics that are claimed below.

1. (canceled)

2. A method of manufacturing a multi-sheet slab of natural stone of reduced thickness and substantially flat, the multi-sheet slab formed from a plurality of blocks of stone material cut into a plurality of laminas, the slab comprising three layers including an upper layer, a central layer, and a lower layer, the manufacturing procedure comprising the following steps:
i) cutting of the blocks of stone material and obtaining pieces with flat surfaces;
ii) classifying the pieces obtained based on quality;
iii) machining of a plurality of outer grooves (4) and a plurality of inner (5) grooves onto faces of one or more of the pieces;
iv) applying a bi-component resin adhesive (6), selected from the group consisting of epoxy, polyurethanes, unsaturated polyester, and combinations thereof, to the faces having the plurality of inner grooves;
v) gluing of the three layers making up the multi-sheet slab, according to the following order:
the upper layer made of one or more pieces classified as a low quality stone (3), laid on a same plane, one alongside the other in an upper part of the slab,
the central layer made of a piece classified as a high quality stone (2),
the lower layer made of one or more pieces of the low quality stone (3), laid on the same plane, one alongside the other in a lower part of the slab;
vi) curing of the resulting glued multi-sheet slab by means of hardening of the bi- component adhesive, at a suitable temperature;
vii) splitting or cutting of the multi-sheet slab through the central layer, obtaining two parts of the slab with materials of different quality;
viii) applying surface treatments;
ix) applying a finishing treatment.
